(19) United States
(12) Patent Application Publication
(10) Pub. No.: US 2019/0212101 A1
(43) Pub. Date: Jul. 11, 2019

(54) Ballistic Resistant Material

(71) Applicant: Christian Ellis, San Diego, CA (US)

(72) Inventor: Christian Ellis, San Diego, CA (US)

(73) Assignee: Alternative Ballistics, Poway, CA (US)

(21) Appl. No.: 16/244,953

(22) Filed: Jan. 10, 2019

Related U.S. Application Data
(60) Provisional application No. 62/616,381, filed on Jan. 11, 2018.

(51) Int. Cl. F41H 5/04; B32B 5/26; B32B 5/12

(52) U.S. Cl. CPC F41H 5/0485; B32B 5/26; B32B 2307/558; B32B 2262/0269; B32B 2571/02; B32B 5/12

(57) ABSTRACT

Improvement in a ballistic resistant material is disclosed. The material uses unidirectional laid aramid of fibers that. The fibers are laid in a unidirectional arrangement that allows the fibers to essentially nest together to create a more dense and thinner material. The fibers can be different and can include fiberglass to graphite or any combination of fibers or alloys that the application requires including electrically conductive and non-electrically conductive, flammable and non-flammable, water restraint to non-water restraint, buoyant and non-buoyant materials. The material is bonded with NANO technology that fills in the gaps in the molecular structure of the adhesives that can contain petroleum and nonpetroleum based adhesives depending on the application.

### CROSS REFERENCE TO RELATED APPLICATION

This application claims the benefit of Provisional Application Ser. No. 62/616,381 filed Jan. 11, 2018, the entire contents of which is hereby expressly incorporated by reference herein.

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC

Not Applicable

### BACKGROUND OF THE INVENTION

### Field of the Invention

This invention relates to improvements in ballistic resistant material. More particularly, the present material is unidirectional laid fibers with NANO technology adhesive to prevent fabric failure.

### Description of Related Art Including Information Disclosed Under 37 CFR 1.97 and 1.98

Ballistic resistant material has evolved from plate or plates of metal or ceramic to more flexible fabrics that displace the impact of a projectile. These materials are design to prevent penetration of a single projectile, and in some cases a limited few projectiles. These materials generally are sacrificed to absorb the impact. After the first impact, the fabric is usually significantly compromised and subsequent projectiles can penetrate through the compromised fabric, ceramic or metal. In a single gun battle a person might experience one or two impacts and the ballistic resistant material will provide protection. In the case of a battle environment a solder may experience many projectiles until they arrive at a safe location or until assistance arrives. The need to provide projection from multiple projectiles is essential.

A number of patents and or publications have been made to address these issues. Exemplary examples of patents and or publication that try to address this/these problem(s) are identified and discussed below.

U.S. Patent publication number 20110003112 was published on Jan. 6, 2011 to Ronald G. Krueger et al., and is titled Ballistic Laminate Structure and U.S. Pat. No. 8,951,924 that issued on Feb. 10, 2015, also to Ronald G. Krueger et al., and is titled Ballistic Laminate Structure Having Tubular Sleeves Containing Bundles of Unidirectional Filaments and Method of Manufacturing the Same. These documents disclose a ballistic-resistant laminate assembly having a pair of films with an array of stacked pairs of first and second of unidirectionally-oriented bundles of high strength filaments therebetween, with the stacked filament bundles being arranged substantially interlinear with adjacent unidirectionally-oriented adhesions between the pair of films. The adhesions form continuous tubular sleeves between the pair of films with the stacked bundles of high strength filaments being substantially free floating yet contained therein. In this publication the adhesive is placed between the fabric layer wherein the fabric layers can split upon impact of a projectile thereby leaving an opening for subsequent projectiles.

U.S. Patent publication number 20130032025 was published on Feb. 7, 2013 to Vernon A. Wright and is titled Penetration Resistant Material. This publication discloses a penetration resistant material can comprise a plurality of layers of loosely-interconnected, mutually nonbonded and non-laminated sheets of ballistic para-aramid synthetic fabric coupled between inner and outer layers of cloth fabric. This publication uses bonding for the layers of para-aramid synthetic fabric, but the bonding is only in selective areas of the material.

U.S. Patent publication number 20140287641 was published on Sep. 25, 2014 to Stephen A. Steiner, III and is titled Layered Aerogel Composites, Related Aerogel Materials, and Methods of Manufacture. This publication discloses composites comprising mechanically strong aerogels and reticulated aerogel structures. The publication includes various nanocomposite aerogel materials that may be prepared to facilitate production of composites with desirable functions and properties. While this patent discloses layers of nanocomposite aerogel materials between the fabric layers, once the nanocomposite aerogel materials is compromised a projectile can penetrate.

What is needed is a ballistic resistant material that can be comprised of a verity of different fibers from cloth fibers, fiberglass to graphite or any combination of fibers or alloys with adhesives have NANO technology that fill in the gaps in the molecular structure of the adhesives. The ballistic resistant material disclosed in this document provides the solution.

### BRIEF SUMMARY OF THE INVENTION

It is an object of the ballistic resistant material that uses unidirectional laid aramid of fibers. The aramid fibers are laid in a unidirectional arrangement that allows the fibers to essentially nest together to create a more dense and thinner material as opposed to laying the fibers at 90 degrees or other angles.

It is an object of the ballistic resistant material to be able to use different fibers including, but not limited to cloth fibers, fiberglass to graphite or any combination of fibers or alloys that the application requires. In general, the thread count per-inch remains consistent to allow for nesting of the layers, but other fabric types with different thread counts can be used to provide blended properties of the different fibers.

It is an object of the ballistic resistant material to use electrically conductive and non-electrically conductive, flammable and non-flammable, water restraint to non-water restraint, buoyant and non-buoyant materials. The ballistic resistant material can contain petroleum and nonpetroleum based adhesives depending on the application.

It is an object of the ballistic resistant material to utilize adhesives that have added NANO technology that fill in the gaps in the molecular structure of the adhesives this both bonds the adjoining fibers and binds the fibers in the cloths. While binding across adjacent fibers reduces splitting the fibers apart, binding the fibers themselves stops splitting the unidirectional fibers that can cause premature failure and projectile penetration.

It is another object of the ballistic resistant material. Unidirectional laid aramid of different fibers combined with NANO adhesives make ballistic restraint materials 20-100 times stronger than current technologies. This produces a safer material or fabric that can withstand multiple closely placed projectiles without failure.

It is still another object of the ballistic resistant material for the layered unidirectional laid fibers to act independently thereby allowing the material to take the impact in one isolated location (point of impact) but when in combination with the NANO adhesives, the fibers not only act independently but each layer absorbs the force (kinetic energy) at the point of impact and spreads it across the material without stretching and pulling the material from all angles towards the point of impact.

Various objects, features, aspects, and advantages of the present invention will become more apparent from the following detailed description of preferred embodiments of the invention, along with the accompanying drawings in which like numerals represent like components.

### BRIEF DESCRIPTION OF THE SEVERAL VIEWS OF THE DRAWING(S)

FIG. 1 shows a detail view of unidirectional laid aramid fibers.

FIG. 2 shows a detail view of unidirectional laid aramid fibers with adhesives that have added NANO technology that fill in the gaps in the molecular structure of the adhesives.

FIG. 3 shows a detail view of multiple layers of unidirectional laid aramid fibers with adhesives that have added NANO technology that fill in the gaps in the molecular structure of the adhesives.

FIG. 4 shows a garment made with the multiple layers of unidirectional laid aramid fibers with adhesives that have added NANO technology that fill in the gaps in the molecular structure of the adhesives.

### DETAILED DESCRIPTION OF THE INVENTION

It will be readily understood that the components of the present invention, as generally described and illustrated in the drawings herein, could be arranged and designed in a wide variety of different configurations. Thus, the following more detailed description of the embodiments of the system and method of the present invention, as represented in the drawings, is not intended to limit the scope of the invention, but is merely representative of various embodiments of the invention. The illustrated embodiments of the invention will be best understood by reference to the drawings, wherein like parts are designated by like numerals throughout.

### ITEM NUMBERS AND DESCRIPTION

19 Ballistic resistant vest
20 Aramid fibers
30 NANO Adhesive
40 Aramid fiber impregnated with NANO adhesive

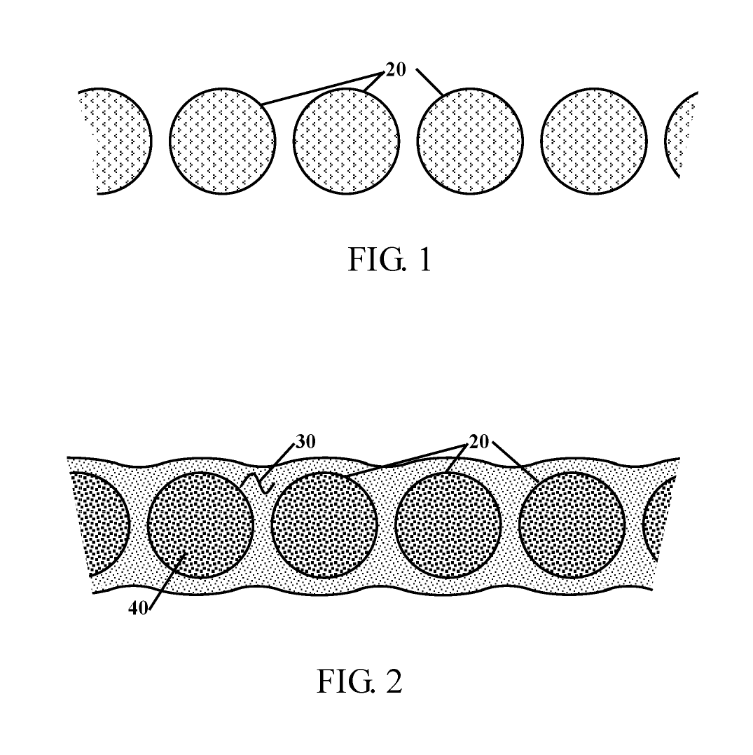

FIG. 1 shows a detail view of unidirectional laid aramid fibers 20. The aramid fibers 20 are unidirectionally laid to increase the density of the proximity of the fibers without increasing the woven thickness of the fabric. The adhesive creates a bond between adjacent fibers as opposed to weaving connecting fibers in a perpendicular manner. While the weaving pattern can be used, compromising the weave will weaken the garment and can result in an area where a subsequent projectile can penetrate. While there is some strength in the base aramid fabric, the adhesion from an impact is with the addition of an adhesive that includes NANO technology.

Because the aramid fibers are not as critical as the adhesive with NANO technology, the aramid fibers 20 can be a number of different types of fibers including, but not limited to cloth fibers, fiberglass, graphite or any combination of fibers or alloys that the application requires. These fibers include both electrically conductive and non-electrically conductive, flammable and non-flammable, water restraint to non-water restraint, buoyant and non-buoyant materials. The ballistic resistant material can contain petroleum and nonpetroleum based adhesives depending on the application. The different uses of the ballistic resistant material provides additional design options that are not possible with current materials that are available today.

The wide diversity of fibers allows the fabric to be custom fabricated to meet the requirements of the customer instead of providing specifications to a customer that requires the finished product. This can be particularly important where the customer requires a water proof garment that needs conductive properties. These needs can be for a navel glove where the conductive properties are needed to use a mobile touch screen device. It would provide ballistic protection and would also allow the user to be submerged without emerging from the water with an engorged glove.

FIG. 2 shows a detail view of unidirectional laid aramid fibers 20 with adhesives that have added NANO technology adhesive 30 that fill in the gaps in the molecular structure of the adhesives. One nanometer is a billionth of a meter, or 10′ of a meter. A few illustrative examples are that there are 25,400,000 nanometers in an inch, a sheet of newspaper is about 100,000 nanometers thick and on a comparative scale, if a marble were a nanometer, then one meter would be the size of the Earth. Nanoscience and nanotechnology involve the ability to see and to control individual atoms and molecules.

The adhesives 30 have added NANO technology that fills-in the gaps in the molecular structure of the adhesives. The adhesive also flows within and impregnate 40 the fibers 20 of the fabric to not only increase the bond from thread to thread, but also increases the strength of each thread. This prevents a rupture or split from a projectile that tries to spread between threads, but also prevents an individual thread from splitting. It prevents both the thread and the gap between the threads from failing.

While most ballistic resistant materials sacrifice their structural properties to absorb and impact, unidirectional laid fibers to act independently thereby allowing the material to take the impact in one isolated location (point of impact) but when in combination with the NANO adhesives 30, the fibers not only act independently but each layer absorbs the force (kinetic energy) at the point of impact and spreads it across the material without stretching and pulling the material from all angles towards the point of impact.

The unidirectional laid aramid of different fibers combined with the NANO adhesives in this document makes the ballistic restraint materials 20-100 times stronger. It can withstand not only a single impact, but because the impact is spread across the material, multiple impacts are absorbed without compromising the fabric. This is particularly important in a gun battle or with rapid fire guns that fire many projectiles, and sometimes in a close pattern. The intent is to prevent a projectile from passing through the fabric where the projectile can enter a person. The spreading of the impact across the garment also helps to reduce point contact that can cause broken bones and soft tissue damage.

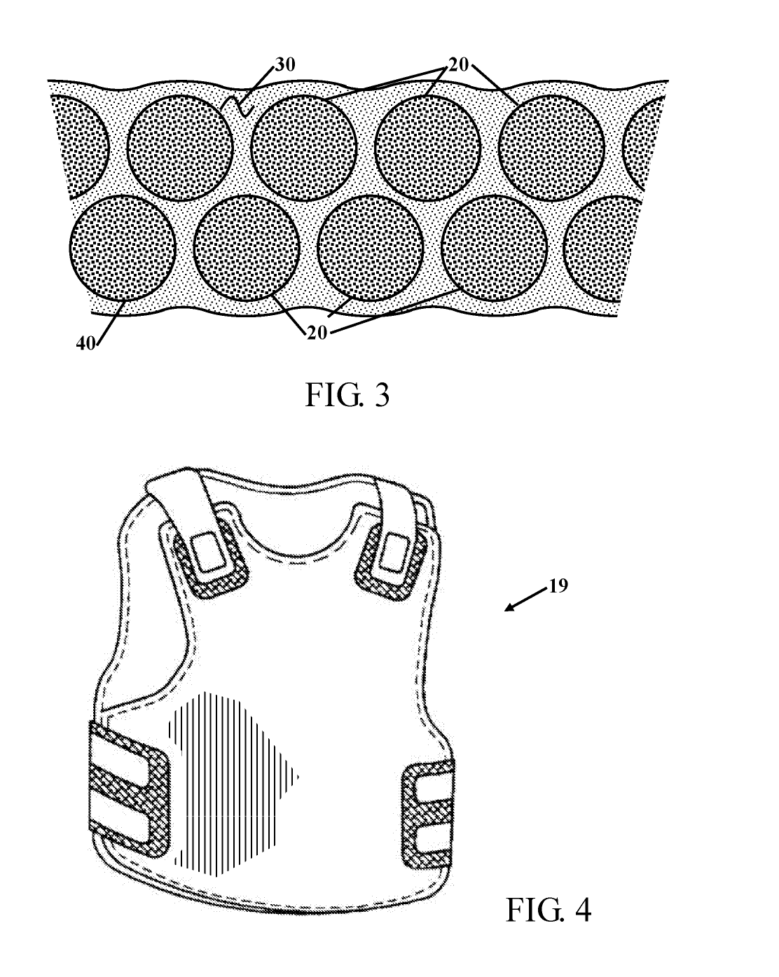

FIG. 3 shows a detail view of multiple layers of unidirectional laid aramid fibers 20 with adhesives that have added NANO technology that fill in the gaps in the molecular structure of the adhesives. In contrast, woven material by its very nature is designed to tangle the bullet in the woven layers upon impact. This is common for ballistic woven material known as Kevlar or other registered names.

As the bullet makes impact it weakens the structural integrity of the rest of the woven material by stretching and pulling the material from all angles towards the point of impact. This allows it to stop a bullet or two and possibly three bullets. Each impact of a bullet in a woven fabric weaken the woven fabric.

Unidirectional laid fibers 20, that are layered, act independently allowing the material to take the impact in one isolated location (point of impact) but when in combination with our adhesives they not only act independently but each layer absorbs the force (kinetic energy) at the point of impact and spreads it across the material without stretching and pulling the material from all angles towards the point of impact. Thus, a far superior ballistic restraint material is obtained that can take 100 or more points of impact from bullets fired from a gun. The NANO adhesives are not affected or weakened by water so extended submersion does not alter the tensile strength of the adhesive bond.

Aramid fibers 20 are a class of heat-resistant and strong synthetic fibers. They are used in aerospace and military applications, for ballistic-rated body armor fabric and ballistic composites, in bicycle tires, and as an asbestos substitute. The thread counts of the unidirectional laid aramid do not affect the ballistic resistance. Other forms of aramid fibers are contemplated as constructed as a laid fabric that is not woven nor unidirectional laid. The aramid is bonded with the NANO adhesive 30.

FIG. 4 shows a garment 19 made with the multiple layers of unidirectional laid aramid fibers with adhesives that have added NANO technology that fill in the gaps in the molecular structure of the adhesives. While this figure is configured as a vest, it should be understood that the garment can take to shape and configuration of other articles of clothing as well as covering walls, doors or vehicles. The unidirectional laid aramid of different fibers combined with our NANO adhesives make our ballistic restraint materials 20-100 times stronger than current technology available on the market. The use of ballistic resistant material to cover sides of a vehicle reduces the weight to make a vehicle projectile resistant. The ballistic resistant material can be placed over a vehicle panel where the metal door. It is also contemplated that the ballistic resistant material can be laid like fiberglass to create a conforming shape of a vehicle. The ballistic resistant material can then be painted or otherwise treated to provide a common appearance as might be found in a vehicle, aircraft or watercraft.

The ballistic resistant material can be comprised of a verity of different materials. Using unidirectional laid aramid of different fibers from cloth fibers, fiberglass to graphite or any combination of fibers or alloys that the application that can require both electrically conductive and non-electrically conductive, flammable and non-flammable, water restraint to non-water restraint, buoyant and non-buoyant materials. The ballistic resistant material can contain petroleum and nonpetroleum based adhesives depending on the application. The garment or fabric protects from multiple close proximity impacts as might be experienced with automatic assault firearms. The ballistic material can be rolled onto itself with the NANO adhesive to bind the overlapping ends.

Thus, specific embodiments of a ballistic resistant material have been disclosed. It should be apparent, however, to those skilled in the art that many more modifications besides those described are possible without departing from the inventive concepts herein. The inventive subject matter, therefore, is not to be restricted except in the spirit of the appended claims.

### SEQUENCE LISTING

Not Applicable.

1. A ballistic resistant material comprising:
at least one layer of unidirectional laid aramid fibers;
a NANO adhesive that both binds the at least one layer of unidirectional laid aramid fibers and impregnates said aramid fibers, and
forming said at least one layer of unidirectional laid aramid fibers with NANO adhesive.

2. The ballistic resistant material according to claim 1, wherein said unidirectional laid aramid fibers are water resistant.

3. The ballistic resistant material according to claim 1, wherein said unidirectional laid aramid fibers are electrically conductive.

4. The ballistic resistant material according to claim 1, wherein said unidirectional laid aramid fibers are flammable.

5. The ballistic resistant material according to claim 1, wherein said unidirectional laid aramid fibers are petroleum based.

6. The ballistic resistant material according to claim 1, wherein said unidirectional laid aramid fibers are a combination of at least two of a group selected from cloth fibers, fiberglass and graphite.

7. The ballistic resistant material according to claim 1, wherein said unidirectional laid aramid fibers are stab or puncture resistant.

8. The ballistic resistant material according to claim 1, wherein said unidirectional laid aramid fibers are cut resistant.

9. The ballistic resistant material according to claim 1, wherein said unidirectional laid aramid fibers are bomb fragment resistant.

10. The ballistic resistant material according to claim 1, is formed into a garment.

11. A ballistic resistant material comprising:
at least one layer of aramid fibers;
a NANO adhesive that both binds the at least one layer of aramid fibers and impregnates said aramid fibers, and
forming said at least one layer of aramid fibers with NANO adhesive.

12. The ballistic resistant material according to claim 11, wherein said at least one layer of aramid fibers are water resistant.

13. The ballistic resistant material according to claim 11, wherein said at least one layer of aramid fibers are electrically conductive.

14. The ballistic resistant material according to claim 11, wherein said unilateral laid aramid fibers are flammable.

15. The ballistic resistant material according to claim 11, wherein said unilateral laid aramid fibers are petroleum based.

19. The ballistic resistant material according to claim 11, wherein said unilateral laid aramid fibers are a combination of at least two of a group selected from cloth fibers, fiberglass and graphite.

12. The ballistic resistant material according to claim 1, wherein said aramid fibers are stab or puncture resistant.

13. The ballistic resistant material according to claim 1, wherein said aramid fibers are cut resistant.

14. The ballistic resistant material according to claim 1, wherein said aramid fibers are bomb fragment resistant.

20. The ballistic resistant material according to claim 11, is formed into a garment.
